(19) United States
(12) Patent Application Publication
(10) Pub. No.: US 2007/0206329 A1
(43) Pub. Date: Sep. 6, 2007

(54) Center rail slider for disk drives

(75) Inventors: Peter Sveniker Shay, Bountiful, UT (US); David C. Deyoung, Riverdale, UT (US)

Correspondence Address: Powell and Associates, P.O. Box 1679, American Fork, UT, 84003, US

(73) Assignee: FUJIFILM Microdisks USA Inc.

(21) Appl. No.: 11/367,740

(22) Filed: Mar. 6, 2006

(51) Int. Cl. G11B 5/48

(52) U.S. Cl. 360/246.6

(57) ABSTRACT

A method and device allows a magnetic disk drive system to avoid thru- talk between opposing read/write devices, or gaps, within heads for magnetic data storage media. Certain head designs for magnetic disk drives require the read/write devices in opposing heads to be situated directly across from each other when considering a line from one of the read/write devices perpendicular through the magnetic disk to the other read/write device. When both read/write devices are operating simultaneously electromagnetic interference, or thru-talk, causes the signal of one or both read/write devices to be corrupted or cancelled. By moving one of the read/write devices a slight distance from the line the interference eliminated and both read/write devices operate properly.

### BACKGROUND OF THE INVENTION

This invention relates to the field of disk drive systems, and in particular, to a method of eliminating thru-talk between opposing gaps on sliders.

Disk drives are commonly used in personal computers, laptops, portable drive devices and other electronic/computer systems to store large amounts of data in a form that can be made readily available to the user. In general, a disk drive, such as a hard disk drive, will include a permanent magnetic media disk that is rotated by a spindle motor. The surface of the disk is divided into a series of data tracks. The data tracks are spaced radially from one another across a band having an inner diameter and an outer diameter. Each of the data tracks generally extends circumferentially around the disk and can store data in the form of magnetic transitions within the radial extent of the track on the disk surface. Typically, each data track is divided into a number of data sectors that can store fixed sized data blocks.

In addition to the magnetic media disk and the spindle motor, a disk drive may have two arms that extend out over the magnetic media disk. Each of these arms will have near the end of the arm a slider containing a magnetic head. The slider is designed to carry the head across the data stored on the tracks as the media spins. The head is used to read the magnetically stored information from the disk.

The two arms of the disk drive are located on opposite sides of the magnetic media disk. They are mounted to a common part such that the slider and head of one arm is directly across the disk from the slider and head of the other arm. In operation the heads of the disk drive arms will track each other radially. In other words, a head on the top side of the magnetic media disk will be in the same radial location on the media as the head on the opposite side of the disk. This applies to “linear” and “radial” actuators equally.

There are multiple ways in which a head is read across a magnetic disk. For instance, hard disk drives, which generally have the magnetic media disk attached within the disk drive, require the heads to “fly”, or in other words, to remain within a range above the media surface during operation. For flexible magnetic media disks the heads will generally have contact with the media as the sliders pinch the media between them. Because of the differing methods between hard and flexible media disks of tracking along the media surface, designers will often utilize one type of slider for a hard disk drive and another type for a flexible media drive.

Each of the heads incorporates a device termed a gap. The gap is a magnetic element that reads from or writes to the magnetic media disk and is located towards the trailing edge of the head. Conventional heads for both hard disk drives and flexible disk drives generally are interchangeable, meaning that the head for the arm on the top of the magnetic media disk will have the same design as the head on the bottom of the magnetic media disk. The gaps, then, for “center rail” heads, are on opposite sides and directly across the media from each other. In situations particularly where the gaps are centered on the head or otherwise directly across the media from each other a phenomenon known as “thru-talk” can occur when both gaps are operational at the same time. Thru-talk, which is similar in nature to cross talk, is generally defined as an electromagnetic disturbance or interference where a signal in one circuit or element confuses or crosses over a signal in an adjacent or opposing circuit or element. Specifically for magnetic media, thru talk is electromagnetic interference between gaps on opposite sides of the thin magnetic media or interference between their respective written tracks. For instance, Servo Track Writers may have gaps on opposing heads operating simultaneously. Thru-talk is the electromagnetic interference of one of the gaps with the signal, such as a data read or data write, of the opposite gap. This magnetic interference can cause the gap to misread or miswrite, or not functionally transmit data at all.

Accordingly, the present invention is designed to eliminate the problem of thru-talk between opposing heads of a magnetic media disk system.

All objects, features, and advantages of the present invention will become apparent in the following detailed written description.

### BRIEF DESCRIPTION OF THE DRAWINGS

FIG. 1 shows the basic structure of a disk drive arm.

FIG. 2 shows how a simple head is structured.

FIG. 3 shows how multiple disk drive arms with heads align when in operation.

FIG. 4 shows alignment of gaps within the opposing heads of FIG. 3.

FIG. 5 shows the alignment of the gaps according to the present invention.

### DETAILED DESCRIPTION OF THE INVENTION

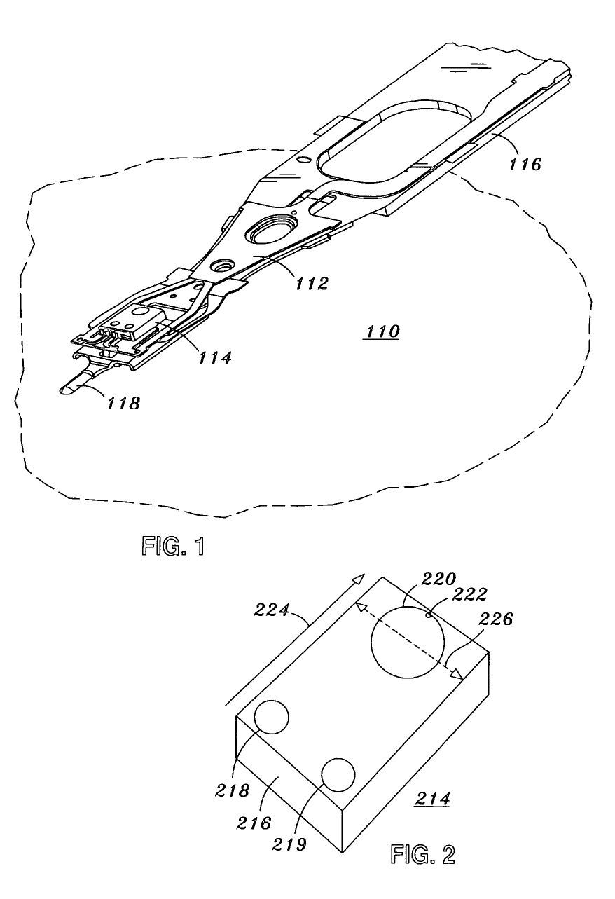

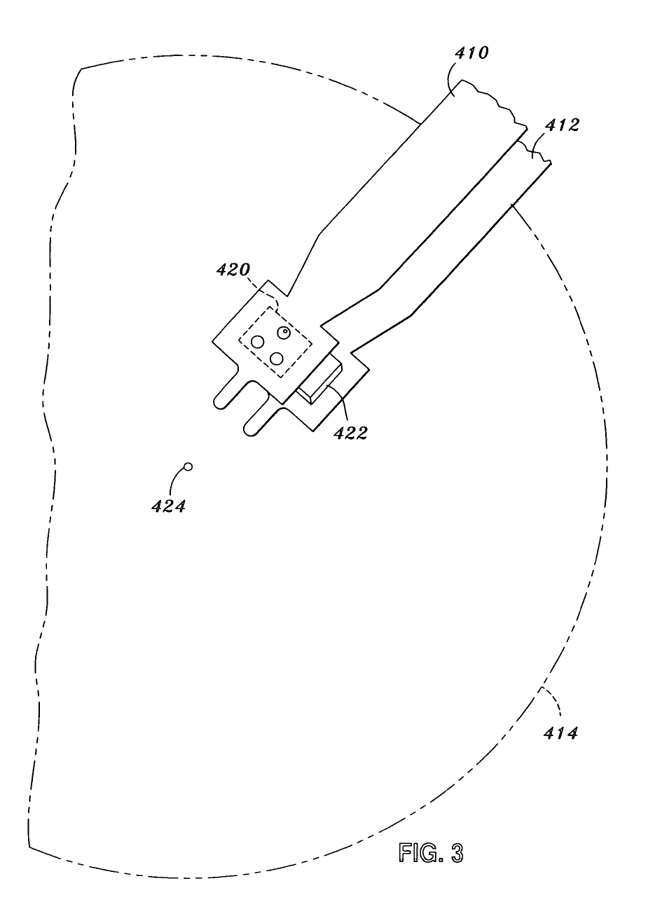

Referring now to FIG. 1 a magnetic media disk drive arm 110 is shown. Arm 110 is part of a magnetic disk drive system (not shown) that would generally include at least one arm 110, disk drive circuitry to control the operation of the disk drive system, a fixed or removable magnetic media disk and a spindle to rotate the magnetic media disk. Arm 110 is movable such that depending upon control signals from the disk drive circuitry, arm 110 moves radially across the magnetic media disk reading and/or writing data to and from the disk. The reading of the data, as will be explained in conjunction with the description of FIG. 2 is performed through a magnetic device called a gap (not shown in FIG. 1). The purpose of arm 110 is to move the gap(s) across the disk allowing the gap to read or write the information which is transmitted along flexible cable 112 to/from the disk drive circuitry. The gap(s) is found at the end of arm 110 in head 114. A structural member 116 allows arm 110 to cantilever head 114 out over the magnetic media disk. A load beam 118 supports the flexure 118A which is the gimbaling element supporting the slider 114 and flex cable 112.

FIG. 2 shows a generic head 214 corresponding to head 114 of FIG. 1. Head 214 comprises a base portion 216, front pads 218 and 219, rear pad 220 and gap 222. Note here that pads 218, 219 and 220 are designed to control on a micro level the height above, or contact with, the magnetic media disk that head 214 experiences. As the magnetic media disk rotates, and it rotates at high speeds, arm 110 swings or translates in a controlled manner, dictated by the disk drive circuitry, in a radial manner over the magnetic media disk. As with any spinning object, the speed at which magnetic media disk is spinning near its center is much less than the speed at which the disk is spinning at its outer periphery. One having an ordinary understanding of air currents and moving objects will recognize that an object such as the magnetic media disk rotating at a high speed immediately above a fairly flat surface, such as head 214, will create air pressure between the disk and head 214. This pressure will cause head 214 to move away from or towards magnetic media disk, depending upon the speed of the disk, the gram load, the design of the profile of the slider 214 surface (air bearing surface), and other conditions. Accordingly, various designs have been generated to control the movement of head 214 vertically up and down from the magnetic media disk. The various designs utilize elements such as pads 218, 219 and 220, as well as “rails” such as the rail in FIG. 3 which will be described subsequently. For hard disk drive disks, head 214 is “flying”, meaning that head 214 is positioned just above magnetic media disk so it doesn't touch during operation. It is important that head 214 be maintained within a specified range of vertical distance from magnetic media disk during operation, and, in FIG. 2, pads 218, 219 and 220 would be designed accordingly. In a somewhat different manner pads 218, 219 and 220 would be designed on head 214 to control vertical distance as well as friction for a flexible magnetic media disk. Head 214 for a flexible magnetic media disk has a “psuedo fly” manner meaning that head 214 rides partially on the magnetic media disk but also has an air pressure between the disk and head 214, thus creating a partial fly. Because this design creates the additional problem of friction in addition to controlling air pressure and thus vertical distance from the media, the pads (such as 218, 219 and 220) are designed somewhat different than those for hard disk drives. It should be noted that pads 218, 219 and 220 of head 214 in FIG. 2 do not represent any particular design for either hard disk drives or flexible media drives, but are shown in a simple illustrative manner to allow for the description of the present invention.

Continuing on with the description of FIG. 2, gap 222 is the element of head 214 that reads from or writes to the magnetic media head. As shown in FIG. 2, gap 222 is generally located at the trailing edge of head 214. This means that the direction of the track(s) being read/written as the disk is spinning is along the path indicated by the arrow 224 and gap 222 is essentially the last part of head 214 that will encounter a specific point of a track as it spins by. Accordingly, pads 218, 219 and 220 will lead on the head to control fly height and friction while gap 222 will follow in its read/write function. As shown in FIG. 2, gap 222 is centered cross-wise on head 214, meaning that when viewed looking at the horizontal distance from side to side of head 214 as indicated by line 226, gap 222 is centered between the two sides.

Referring now to FIG. 3, arm 410 and arm 412 are shown facing each other in a manner to allow a magnetic media disk 414 (which can be either a permanent hard disk or a removable flexible disk) to spin between them. When disk 414 is inserted between arms 410 and 412, heads 420 and 422 are on opposing sides of disk 414. In FIG. 3 heads 420 and 422 are represented by generic head 216 illustrated in FIG. 2, but one skilled in the art will recognize that heads 420 and 422 can be of varying designs. In operation, as disk 414 spins about spindle 424 arms 410 and 412 move on a path between an inside diameter location and an outside diameter location on disk 414 during read or write operations. By moving arms 410 and 412 back and forth heads 420 and 422 can be positioned over designated tracks on disk 414.

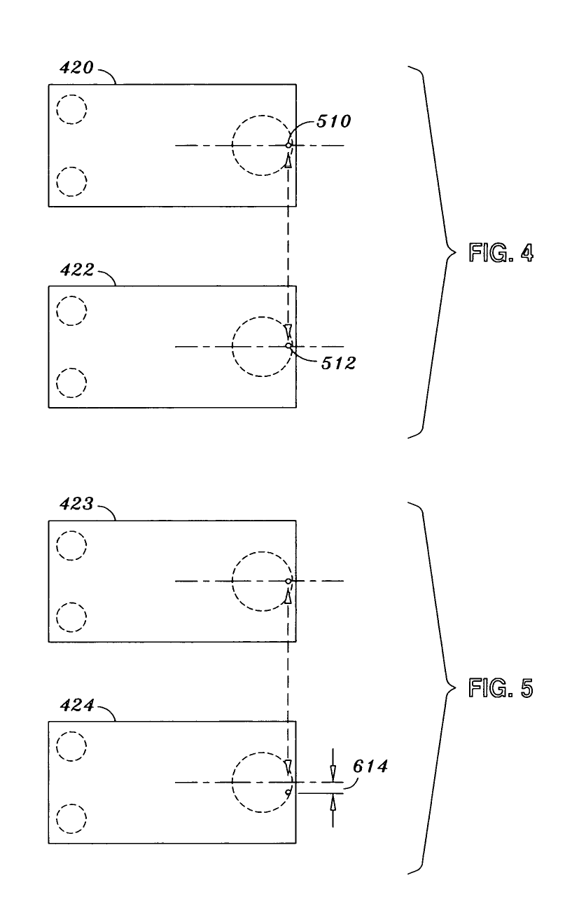

FIG. 4 represents heads 420 and 422 of FIG. 3 when positioned opposite each other in operation as represented in FIG. 3. FIG. 4 shows that when opposite each other gaps 510 and 512 of heads 420 and 422 are also directly opposite each other. During operation opposite positioning of gaps 510 and 512 causes thru-talk between the gaps. Gaps 510 and 512, as explained earlier, are the devices that read the magnetically stored data that resides on disk 414, or writes the data to be stored onto disk 414. As the data is being read or written magnetic signals are received/transmitted from gaps 510 and 512. Often when data is read from or written to the data tracks, only one of gaps 510 and 512 will operate in a single instance. In this case thru-talk may not be a significant matter. However, and in particular, when servo information is being read or written in the servo space, both gaps 510 and 512 have the potential of operating simultaneously. This causes the magnetic signals from the opposing gap 510 and 512 to collide and interfere with each other. Sometimes the magnetic signals will alter the magnetic waves causing a recording or reading error.

FIG. 5 shows an embodiment of the present invention solving the problem of thru- talk. As shown in FIG. 4, identical sliders 420 and 422, with magnetic head gaps centered on the slider, will have those gaps directly across the media from one another when mounted in the drive. In contrast, sliders 423 and 424, also identical but with the magnetic head gap offset from the centerline of the slider by distance 614, giving an “in plane” distance between the head gaps of two times the distance 614. This differential (twice the distance of 614) keeps the magnetic signals received/transmitted by gaps 610 and 612 from altering/canceling the signals when gaps 610 and 612 are operating simultaneously. The present invention will work equally well with any head design where opposing gaps cause thru-talk.

Although the description of the present invention has utilized various embodiments, it will be recognized that the present invention is not limited to the specific embodiments described. Rather, the present invention encompasses all variants incorporating the essence of the ideas presented in the above description.

What is claimed is:

1. A method comprising:
determining that there may be interference between read/write devices on heads that are situated opposite a location for a data storage media from each other, each one of the heads comprising one of the read/write devices where the read/write device on a first of the heads must be situated across the media location from the read/write device on a second of the heads; and
situating the read/write device for the first of the heads in an offset position so the read/write device for the first of the heads is not directly opposite the media location from the read/write device of the second of the heads when considering a line from the read/write device of the second head perpendicular through the data storage media location.

2. A device comprising:
a plurality of heads, each of the plurality of heads attached to an associated support;
the plurality of heads situated on opposite sides of a data storage media location, the data storage media location allowing a media to be inserted therein;
each of the plurality of heads having a read/write device incorporated therein;
wherein a first of the read/write devices has a distance slightly away from a line extending from a second of the read/write devices running perpendicular to the data storage media location; and
wherein the distance is an offset to avoid read/write signal interference between the first and the second read/write devices.

3. A device according to claim 2 wherein the media is a magnetic disk.

4. A device according to claim 2 wherein the media is affixed in the data storage media location.

5. A device according to claim 2 wherein the media is a removable flexible magnetic storage disk.

6. A device according to claim 2 wherein the interference is electromagnetic interference caused by the read/write devices situated directly across from each other and operating at the same time.
